(19) United States
(12) Patent Application Publication
(10) Pub. No.: US 2006/0198393 A1
(43) Pub. Date: Sep. 7, 2006

(54) Method for transmitting additional information by compression of the header

(76) Inventors: Catherine Lamy, Paris (FR); Pierre Vila, Rueil-Malmaison (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/563,447

(22) PCT Filed: Jun. 30, 2004
(86) PCT No.: PCT/EP04/51311

§ 371 Date: Jan. 4, 2006

(30) Foreign Application Priority Data
Jul. 4, 2003 (FR) 0308235
Aug. 1, 2003 (FR) 030955.3

(51) Int. Cl. H04J 3/16; H04J 3/22

(52) U.S. Cl. 370/469

(57) ABSTRACT

Method for exchanging data between two layers of a network stack in a data transmission system comprising a header compression and decompression mechanism, comprising at least the following steps: transmitting the initial packets to a packet header compression/reconstruction step, and simultaneously transmitting additional information to a shaping step so as to produce said information in additional packets compatible with the network stack.

The invention relates to a device and a method making it possible to transmit information between two layers of a network stack.

It applies in the field of transmissions with losses due to the transmission medium (e.g.: wireless transmissions). It applies in any data transmission system comprising a header compression and/or decompression mechanism.

The transmission of text, images and video by way of channels of limited bandwidth may be significantly affected by errors due to the channel. Such systems traditionally use source coders to reduce the redundancy of the source symbols and thus to reduce the amount of information to be transmitted, then error (or channel) corrector coders to increase the robustness of the information transmitted over the channel. This is conventionally achieved by virtue of the variable-length code compression standards (VLC: Huffman codes, arithmetic codes etc.) and of the channel coding of the modulation (designated overall in what follows by the generic term “channel coder/decoder”) so as to increase the robustness of the transmission over the channel. A more integrated optimization may be obtained by developing a strategy of source-channel joint coding/decoding. The key point then consists in making appropriate use of the redundancy of the residual source in respect of the decoding part. This redundancy may be regarded as a form of implicit channel protection by the decoder and be utilized in such a way as to offer an error correction capability.

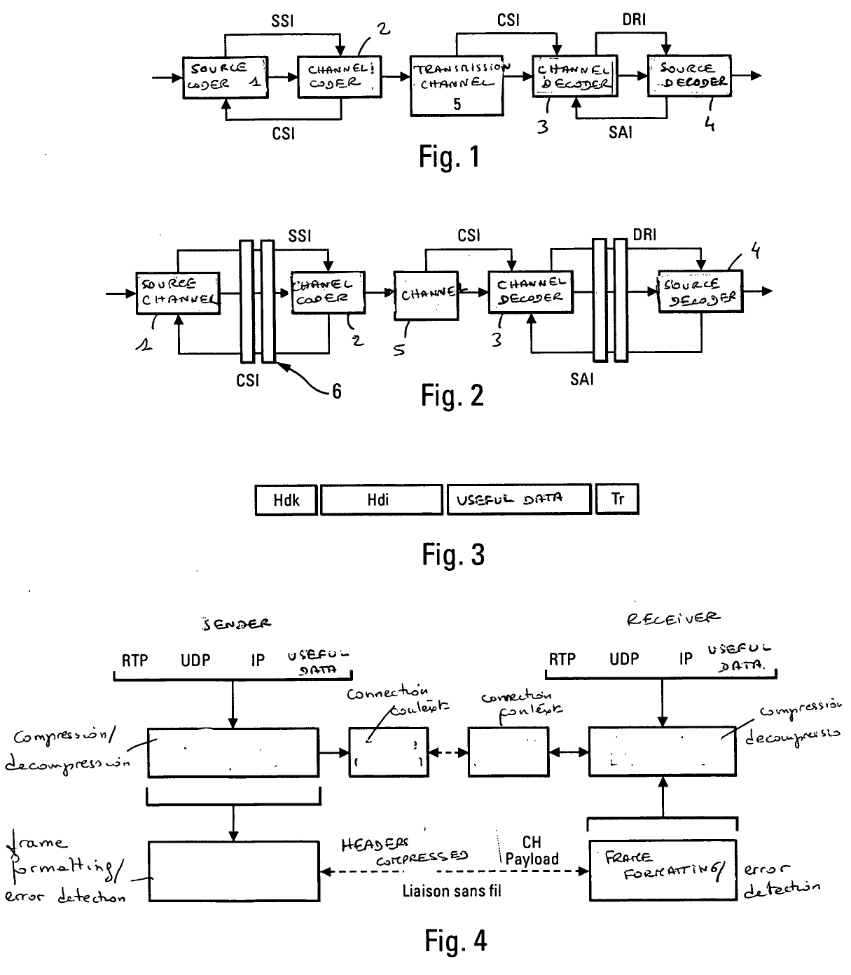

In simple systems where the source coder 1 and the channel coder 2 (respectively the source decoder 3 and the channel decoder 4) are directly interfaced, the techniques of source-channel joint coding may be implemented easily by exchanging the information between the various blocks, as shown in FIG. 1. The reference 5 designates the transmission channel.

On the transmitter side, the information data regarding the sensitivity of the source to channel errors (Source Significance Information or SSI), may be transmitted from the source coder to the channel coder so as to allow the application of techniques such as unequal error protection (or UEP). In order to adapt the source coding rate and channel coding rate to the conditions of the propagation channel, it is also useful to provide information relating to the state of the channel (Channel State Information or CSI) to the source coder and to the channel coder. In the field of digital communications, the traditional decoding procedures applied to such concatenated schemes, which allow high coding gains with reasonable complexity and robustness to transmission errors, may be based on “hard” decisions or on “soft” decisions or “weighted” decisions depending on whether the signal is binary or analogue.

The decoding procedures based on soft decisions make it possible to asymptotically improve performance, in terms of error, by several decibels over most of the channels. The soft information therefore appears to be necessary in the field of modern communications. In order to allow soft decoding, the internal decoder must provide a soft output to the external decoder and vice versa in the case of iterative decoding. Consequently, on the receiver side, the soft outputs of the channel and the CSI information relating both to the amplitude of the fading and to the noise, may be provided by the channel to the channel decoder which will carry out the soft input soft output (or SISO) channel decoding.

Moreover, the soft output of the channel decoder or the decoder reliability information (DRI) will be transmitted to the source decoder which will carry out the soft input source decoding and will provide a soft output for the source information, that is to say the a posteriori information of the source (source a posteriori information or SAI) may be retransmitted to the channel decoder to perform the channel decoding controlled by the source and possibly the source-channel iterative decoding.

However, source and channel coders/decoders are often devices belonging to a network which are unable to exchange information on account of the protocol layers 6 which separate them, as is illustrated in FIG. 2.

The various items of information to be exchanged between the decoders must pass through various levels of network protocols. However, to remain compatible with the recommendations and the implementations [1], such transmissions must not interfere with the regular use of the network. This implies that the additional information is transmitted in a manner transparent for the protocol stack.

OSI Layer Model

In practice, the transfer of the DRI and SAI information between the source coder and the channel coder will consist in transmitting quantized values through the protocol stack. The problem of transparency becomes that of the transmission of several binary inputs (typically the quantization may be done on 4 or 5 bits) instead of a single binary input for each information bit considered. However, as the transmission is not done directly but through a network, the information bits which are of relevance to the application constitute only a part forming the useful part of the sequence actually sent. As is illustrated in FIG. 3, this sequence sent is composed of the useful data flanked by headers and possibly packet terminations (for example control fields such as cyclic redundancy codes CRCs).

More explicitly, the transmission of data in the down direction (from the application package level to the network access level) through the protocol stack will consist at each transition of layers in the execution of the following steps [1]:
obtain the sequence of data S_{L+1} of the higher layer,
generate the ad hoc header and possibly control fields,
construct the new sequence of data S_{L} by concatenating the header, the sequence S_{L+1} and the control field. This step is possibly carried out by chopping the data sequence into several blocks, doing so while taking account of any size limitations imposed by the protocol. In the latter case, the resulting packets may have a lower number of headers but retain a similar makeup. They therefore alter in a similar manner to that of the undivided packets.

On the other side of the channel, the up transmission through the protocol stack will consist at each transition of layers in:
obtaining the sequence of data S′_{L-1} of the lower layer, decapsulating the ad hoc header (and possibly the packet termination) to create the sequence S′_{L}. This step is possibly carried out at the same time as the requests for retransmission in the case where the decapsulation shows that the data stream was corrupted,
dispatching the sequence of data S′_{L} to the higher layer if the control field is correct.
   Solutions for Exchanging Information Through the Layers of the Protocol Stack

To exchange information between the layers without modifying the protocol stack, a first idea would be to sidestep the stack and to use a parallel link, in particular when working on the same machine. Certain links exist in practice on a computer between the low-level layers (kernel) and the user level without passing through the protocol stack. For example, it is possible to use dedicated drivers with iotcl links [3] or specific means, for example means of selection by the BPF method (Berkeley Packet Filter [4]) which allow the application package layer to capture and to filter the data at the level of the data links.

However, such solutions are applicable only locally (on one and the same machine) and correspond to a case where the data must not cross the protocol stack. They therefore do not apply in the case where the network access level and the application level cannot be connected in this way.

Another solution proposed allows exchange of information such as the reliability or soft information through a network between the source decoder and the channel decoder, while avoiding any interference with the standard use of the network and consequently, while avoiding the need to redefine existing protocols. Presented in reference [5], this “transparency for the network” solution relies on the presence of adaptive layers which make it possible to take account of the existing quality of service mechanisms QoS, and on the validation of the concept in a Berkeley Software Distribution Linux environment. Such a solution has the advantage of being able to adapt to any protocol stack and to any network. However, it imposes the requirement for perfect knowledge of the protocol stack at the network access and application level. It is moreover fairly complex since it makes it necessary to decapsulate once more at the physical layer level to modify the data transmitted.

These solutions have the major drawback of requiring a mechanism capable of constructing or of modifying the content of the IP packets that are valid at the physical level and at the network access level.

Header Compression

Wireless communications or links are characterized by a limited bandwidth which, in practice, limits the throughput of information sent or received by a user. Such a link is traditionally viewed as a bottleneck (especially for binary error BER and frame error FER rates between 10⁻² and 10⁻⁵) for the transmission of data since they often lead to multiple retransmissions of the data, which aggravate the problem of the narrowness of the limited band.

Consequently, the direct transmission of the IP packets over physical wireless links leads to a significant wastage of the useful binary information throughput, since in fact the headers of the RTP, UDP and IP layers add an appreciable load to the useful data. This load may readily be reduced since these headers are often redundant, be it inside the header itself or with the headers preceding or following the packet. In a real-time data context, where the packets must be transmitted rapidly, the loads resulting from the header may reach as much as several times the size of the useful data (as much as a factor of around 3). Moreover the error correction mechanisms (Forward Error Correction or FEC) applied to the MAC data link layer are generally chosen to guarantee a low error rate, doing so in order to ensure that the IP packets will not be rejected when their CRC is verified in layer 3 (IP). This leads to global protection of the IP packet at the highest level, when in fact only the header is especially sensitive to errors. Nevertheless, the multimedia data transmitted may often tolerate a higher error rate by virtue of the various correction mechanisms applied to the source coders (robustness of the decoding, masking techniques, etc.).

To address the double objective of header reduction and of increased robustness of the header for wireless links, a new protocol proposed by the IETF has been introduced in versions 5 and 6 of the UMTS by the 3GPP working group. This scheme, designated by the expression “robust header compression” (or ROHC) has been standardized by the IETF under the reference RFC 3095 [6]. The principle of the ROHC mechanism is shown in FIG. 4. The standardization of the RTP/UDP/IP header compression for UMTS links is currently undergoing study by the IETF [7].

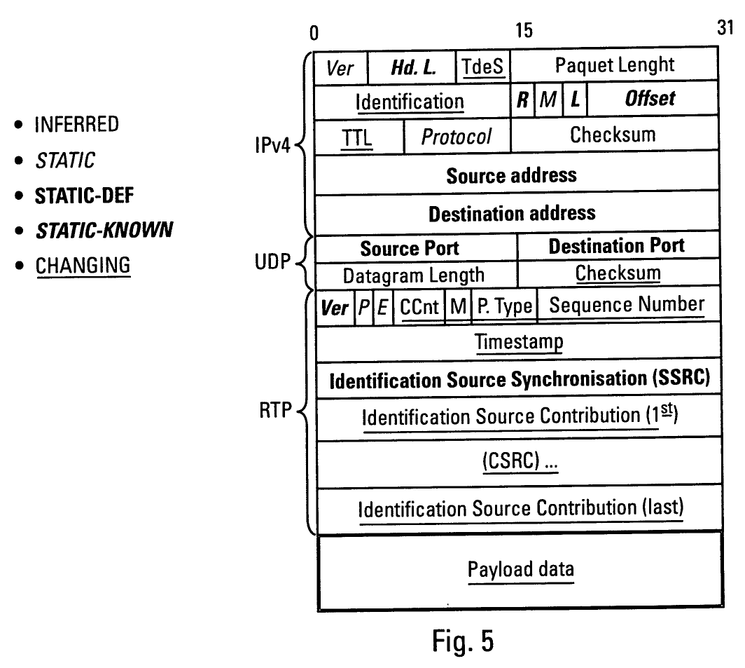

FIG. 5 affords a better illustration of the ROHC mechanism. The IP, UDP, RTP variable header fields at the protocol stack level may be classified as follows: INFERRED (described): data which may be derived directly from the other fields of the header. They are not transmitted.

STATIC: static fields for the entire data transmission.

They are transmitted once only.

STATIC-DEF: fields defining the data flow. They are managed like the STATIC classification.

STATIC-KNOWN: fields with known values. They are not transmitted.

CHANGING: fields whose values change regularly, either randomly, or periodically. They are transmitted in full.

It is thus easy to understand that the compression rate obtained is fairly significant and makes it possible to save a “large” transmission bandwidth. This available bandwidth may be used to better protect the extremely fragile headers, the entire data or else transmit more information.

The invention proposes in particular a solution allowing exchange of information (CSI, SSI, DRI, SAI, etc.) between the source decoder and the channel decoder in the presence of intermediate network layers without modification of these layers. It is then possible to use the information exchanged to improve the decoding performance, for example by carrying out soft decoding by virtue of the reliability information (DRI, SAI).

In the subsequent description, the expression “down direction” designates the transmission of information from the application package layer to the network access layer and the expression “up direction” designates the transmission of information from the network access layer to the application package layer.

The invention relates to a method for exchanging data between two layers of a network stack in a data transmission system comprising a header compression and/or decompression mechanism. It is characterized in that it comprises at least the following steps:
transmitting the initial packets to a packet header compression/decompression step, and simultaneously
transmitting additional information to a shaping step so as to produce said information in additional packets compatible with the network stack.

The transmission of the information flowing from the network access level to the application package level, comprises for example at least the following steps:
differentiating the information originating from the transmission channel or from the channel decoder into a stream of initial packets and a stream of previously quantized additional information,
transmitting the coded initial packets and the additional information to a header decompression step,
shaping the quantized additional information as a function of the characteristics of the protocol stack,
transmitting the two streams thus obtained to a source coding step or to a source decoding step.

The transmission of information flowing from the application package level to the network access level, the method may comprise at least the following steps:
differentiating the packets originating from the protocol stack into a stream of initial packets and a stream of additional information packets,
compressing the headers of the initial packets and transmitting them to a channel coding step,
shaping the additional information by extracting some additional information for transmission to the channel coding step,
transmitting the stream generated by the channel coding for sending to the transmission channel.

The transmission of information flowing from the application package level to the network access level, the method comprises for example at least the following steps:
differentiating the packets originating from the protocol stack into a stream of initial packets and a stream of additional information packets,
compressing the headers of the initial packets and transmitting them to a channel coding step of the access layer,
shaping the additional information by extracting some additional information for transmission to the channel decoding step,
transmitting the stream generated by the channel coding for sending over the transmission channel.

The transmission of information flowing from the application package level to the network access level, may comprise at least the following steps:
differentiating the packets originating from the protocol stack into a stream of initial packets and a stream of additional information packets,
compressing the headers of the initial packets and transmitting them to a channel coding step,
shaping the packets transporting the additional information quantized by header compression as a function of the characteristics of the protocol stack for transmission to the channel coding step,
transmitting the streams generated by the channel coding for sending over the transmission channel.

The present invention has in particular the following advantages:
It is compatible with the existing IP networks which implement the header compression process. It makes it possible to transmit additional information via the header compression and reconstruction mechanism in return for a lesser increase in digital complexity.
It can be applied while using the quality of service tools proposed by the IETF for the OSI protocol stack.

It makes it possible to benefit from knowledge of the elements available at the level of data layers of the protocol stack, these elements not customarily being transmitted.
It makes it possible in particular:
   to transmit additional information such as the reliability of the decoded bits, the information on the state of the channel or of the source (statistics, etc.) while remaining compatible with the OSI recommendations,
   to locate the information necessary for generating headers of additional valid packets and possibly to modify the headers of the initial packets according to the requirements of the user at the network access level,
   to extract the additional information at the network access layer and to use it as useful data for the valid additional packets transmitted by a port dedicated to an application level.

Other advantages and characteristics of the present invention will become better apparent on reading the description which follows given by way of wholly nonlimiting illustration appended with the figures which represent:

FIG. 1 a generic scheme for joint source channel decoding,

FIG. 2 a joint source channel decoding on a network,

FIG. 3 a principle of syntax for a packet generated by a protocol stack,

FIG. 4 the principle of the ROHC mechanism,

FIG. 5 an exemplary classification of the header fields for an RTP/UDP/IPv4 stack,

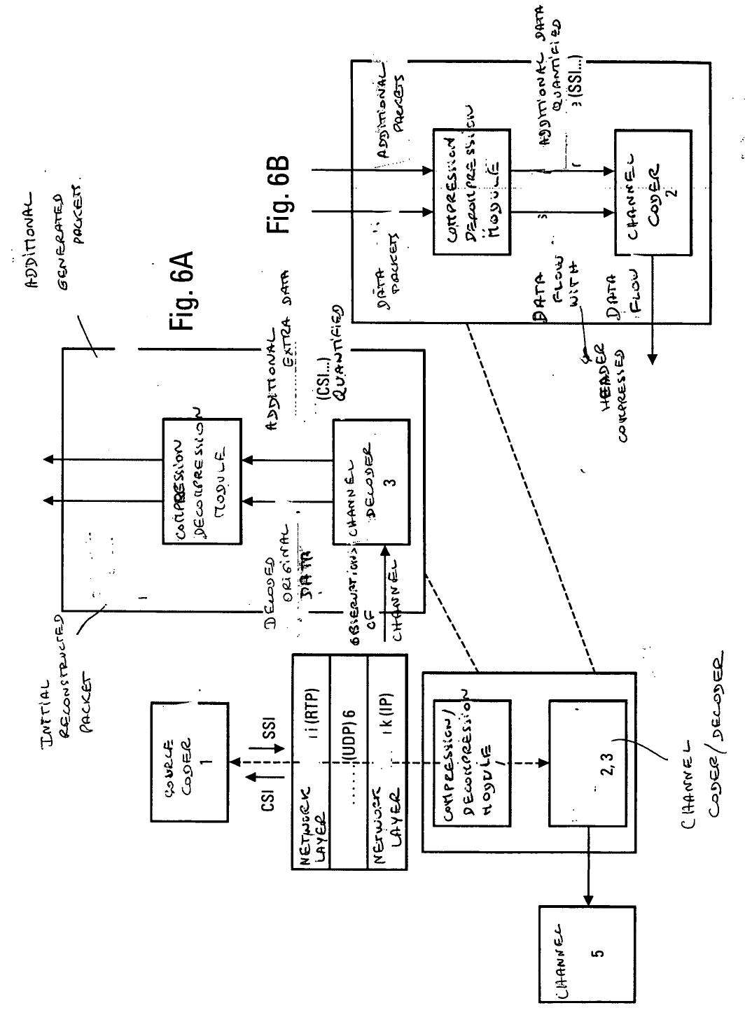

FIGS. 6A and 6B a scheme for the transmissions of information on the sender side,

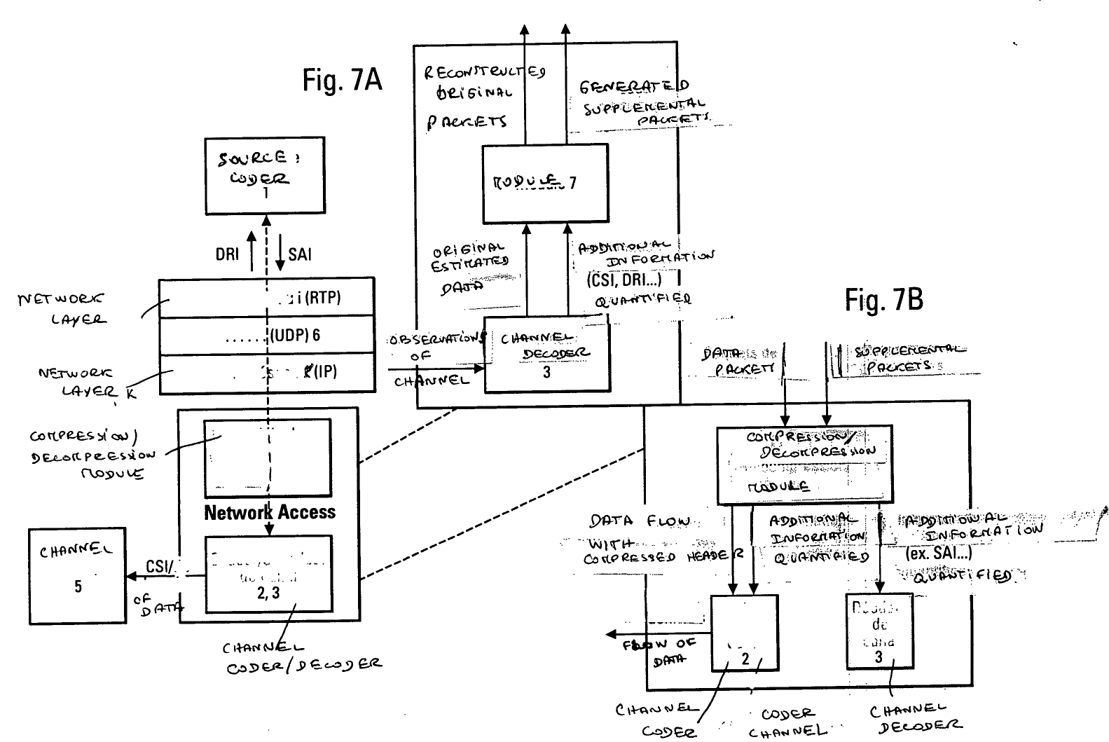

FIGS. 7A and 7B a scheme for the transmissions of information on the receiver side,

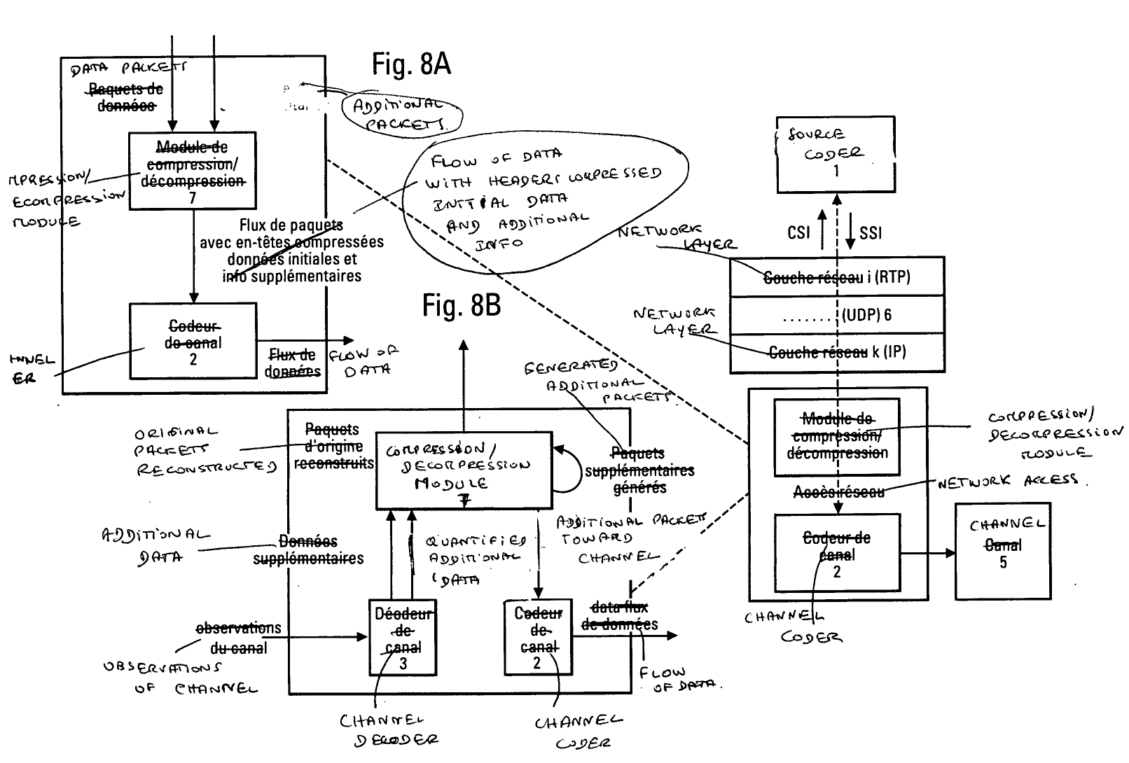

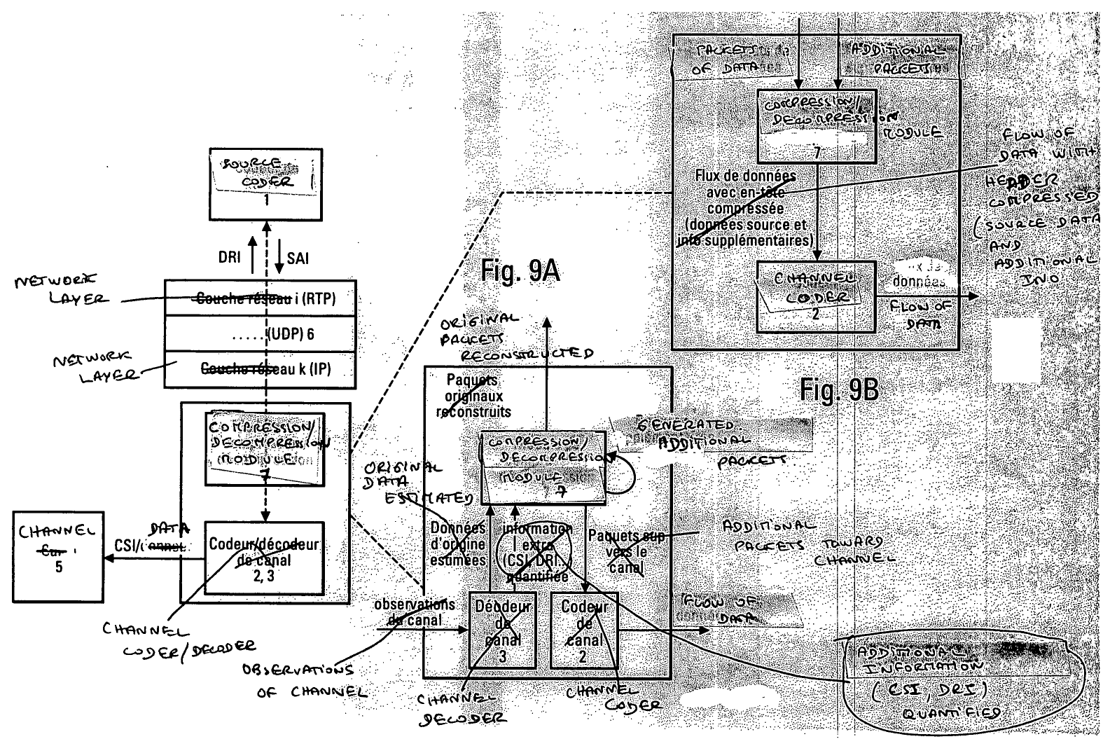

FIGS. 8A and 8B, the exchanges of information from the sender to the receiver,

FIGS. 9A and 9B, the exchanges of information from the receiver to the sender in the case of the existence of a return channel or for a bidirectional transmission,

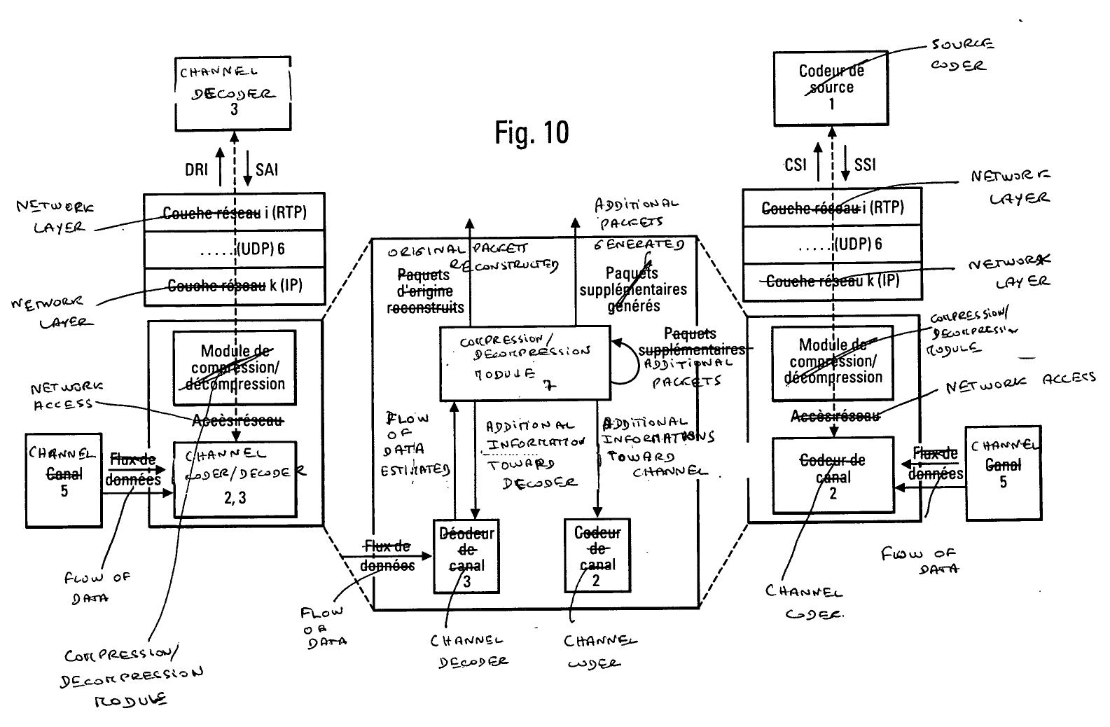

FIG. 10, the processing of the information at the compression/decompression module level,

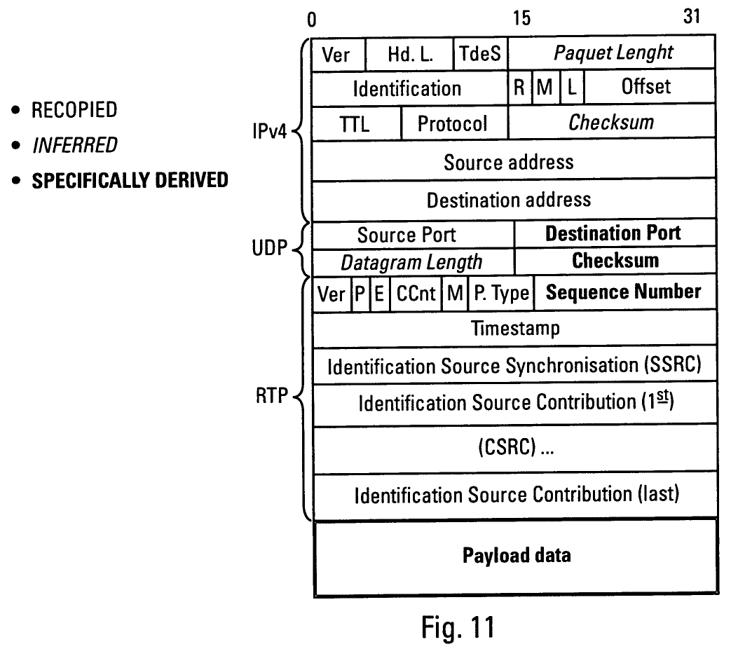

FIG. 11 an exemplary generation of header fields for additional packets in an RTP/UDP/IPv4 stack,

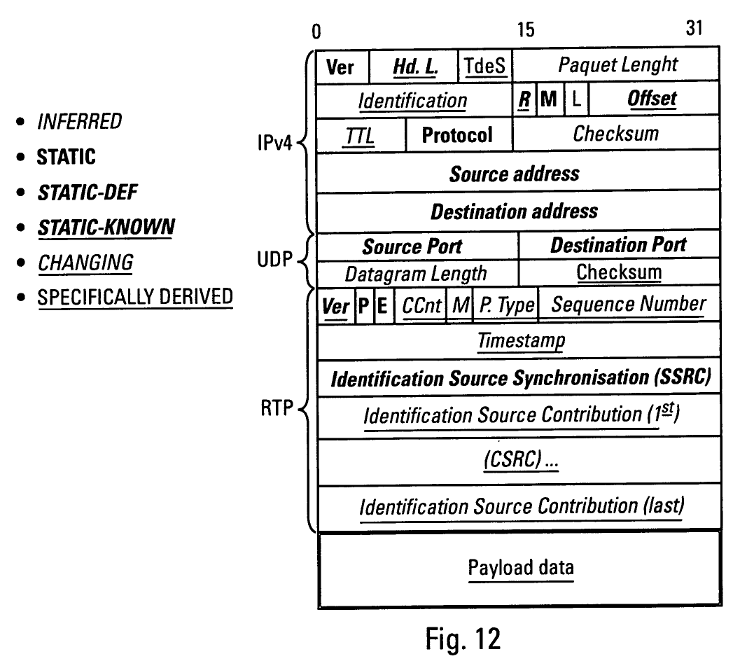

FIG. 12 an exemplary classification of header fields for original packets in an RTP/UDP/IPv4 stack,

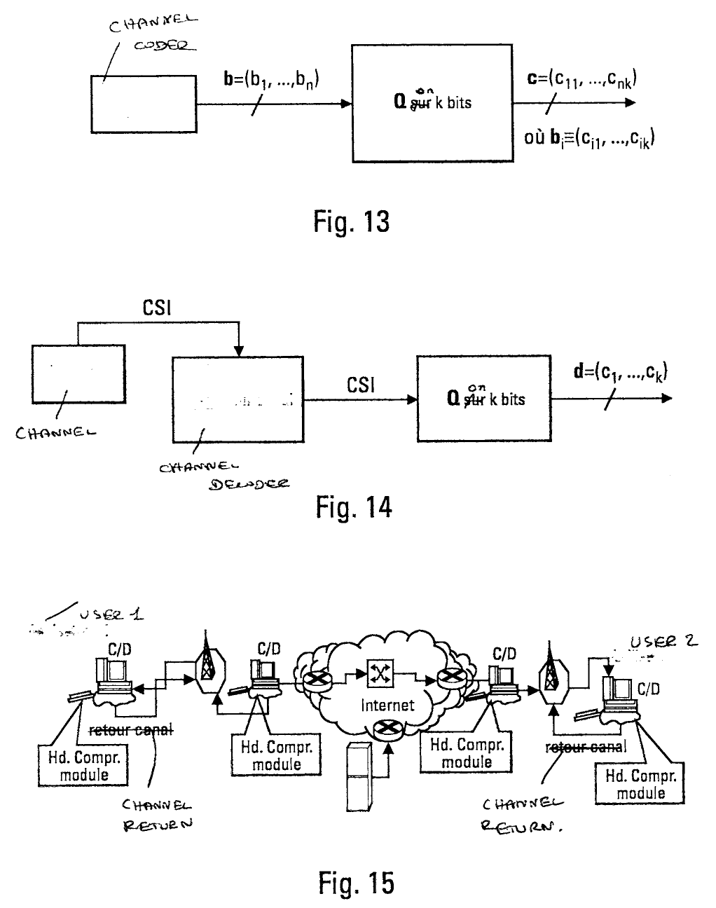

FIGS. 13 and 14 two examples of extraction of additional information,

FIG. 15 an exemplary application of the invention in a context of wireless transmission with header compression.

To summarize, the additional information transmitted from the network access level to the application level is placed in valid packets generated by the header compression module in parallel with the transmission of the original data. This integration within the reconstruction process presupposes that the syntax be used to construct additional packets is known and that the syntax of the reconstructed packets of the original data may be modified as a function of the user's wishes. In a similar manner, the additional information to be transmitted from the application package level to the network access level is transmitted via additional packets which are intercepted by the header compression/decompression module and which are extracted so as to be used according to the users' requirements.

The compression/decompression module 7 is a module suitably adapted for implementing a header compression mode and a decompression mode, according to the direction of transmission of the information. In the up direction, the compression/decompression module operates in decompression mode while in the down direction, it operates in compression mode.

FIGS. 6A and 6B describe an example of existing exchanges on the sender side E of the transmission having the capability of transmitting additional information.

The architecture of the sender E is similar to that described in FIG. 4, where the source coder 1 is linked up with a part comprising a header compression/decompression module 7 and a channel coder 2/decoder 3 by way of a protocol stack 6 comprising several network layers (i, . . . k). In the (conventional) case where a return path exists or when the transmission is bidirectional, the access layer on the sender side also comprises a channel decoder 3 allowing it to receive and to decode the return information, also called observations of the channel.

FIG. 6A schematically shows the exchanges in the “up” direction from the network access layer to the application package layer. The compression/decompression module 7 operates in decompression mode. The observations originating from the channel 5 are transmitted to the channel decoder 3 which generate a packet of estimated original data Pₑₛₜ and a flow of additional information quantized Supq according to techniques of which an example is given by way of wholly nonlimiting illustration. These two streams are transmitted to the header compression/decompression module 7 which applies a standard processing to the original data packets and which transforms the additional information into additional packets compatible with the protocols transmitted to the layers.

The additional information contained in the packets is thereafter used for example to determine the parameters of the source coder as a function of the state of the channel (CSI).

FIG. 6B schematically shows the existing exchanges in the down direction between the application package level and the network access level.

The initial packets and the packets containing additional information quantized at the level of the source coder 1 are transmitted to the header compression module 7 which differentiates them for example by means of a particular header field (for example the UDP port number). The latter compresses the headers of the initial packets. It recovers the quantized information. The two streams thus generated are transmitted to the channel coder 2 which differentiates them.

Depending on the fixed value of the header field as a function of the user's requirements, the header compression module recovers the quantized additional information by extraction of the differentiated packets so as to transmit them directly to the channel coder, in a manner synchronous or not synchronous with the initial packets. In the case where the additional information (for example SSI) is not directly related to given initial packets, the latter may be absent and only the additional information transmitted. The channel coder dequantizes this information and then uses it (for example the SSI which may make it possible to afford unequal protection of the data (Unequal Error Protection or UEP)).

In the case where the additional information is detected as being intended for the channel decoder 3 of the receiver, the packets containing the additional information have their headers compressed by the header compression module and transmitted to the channel coder 2 for coding and sending over the channel 5. The frames sent are then received and decoded at the receiver and are uploaded to the level of the compression/decompression module 7 of the receiver which will recognize the packets destined for the channel decoder and will transmit them to it.

FIGS. 7A and 7B represent the exchanges of information which occur on the receiver side. The architecture of this receiver is similar to that of the receiver of FIG. 4.

FIG. 7A schematically shows the exchanges in the “up” direction from the network access layer to the application package layer. The observations are received by the channel decoder 3 which generates the original estimated data (estimated useful data) and quantized additional information (for example SAI, DRI, etc.) according to the procedures of which an example is detailed hereinafter. These two streams are transmitted to the header compression module 7 which generates packets containing reconstructed original data and packets containing additional information. This information being typically generated by quantization of the soft information output by the decoder 3.

FIG. 7B schematically shows the exchanges of information in the down direction from the application package layer to the network access layer. The packets containing the useful data and the packets containing the additional information are transmitted to the header compression module 7 which generates useful data packets with compressed headers and transmits them to the channel coder 2 for sending over the channel 5 (in the case where a return channel exists or when the transmission is bidirectional) as well as the quantized additional information, which may be destined either for the channel decoder 3 or for the channel coder 2 if it exists.

The various mechanisms described in FIGS. 6A and 6B apply respectively for FIGS. 7A and 7B.

FIGS. 8A and 8B represent the exchanges of information which occur from the sender to the receiver. The architecture of this receiver is similar to that of the receiver of FIG. 4.

FIG. 8A schematically shows the exchanges of information in the down direction from the application package layer to the network access layer. The packets containing the useful data and the packets containing the additional information are transmitted to the header compression module 7. The latter differentiates the additional packets and finding them destined for the receiver applies the same processing to them as the initial data packets: on output from the header compression module 7, we therefore obtain a stream that is undifferentiated at the input of the channel coder 2, which will code them and transmit them over the channel 5. The interpretation of the additional data is detailed in FIG. 10.

FIG. 8B schematically shows the exchanges of information in the up direction from the network access layer to the application package layer. The presence of a return channel or a bidirectional transmission, hence the presence of a channel decoder at the sender is assumed here. The observations made on the channel are provided to the channel decoder 3 which provides them to the decompression module. This decoder is also able to provide quantized additional information (e.g. CSI) to the decompression module 7. The decompression module 7 then processes the various streams received. It differentiates them and reconstructs the original packets but also it generates as appropriate additional packets, whose headers will be compressed by the compression module before resending over the channel to the receiver by the channel coder 2.

FIGS. 9A and 9B represent the exchanges of information which occur from the receiver to the sender in the case where a return channel exists or for a bidirectional transmission. The architecture of this receiver is similar to that of the receiver of FIG. 4.

The various mechanisms described in FIGS. 8A and 8B apply respectively to FIGS. 9A and 9B.

FIG. 10 represents the processing of the additional information at the level of the compression/decompression module. This processing is similar for the sender or for the receiver. The difference is the targeted application package module: source coder 1 or source decoder 2. The undifferentiated stream of data originating from the channel 5 is received and decoded by the channel decoder 3 and transmitted to the header decompression module 7. The latter differentiates the packets, reconstructs the original packets of data and as appropriate, transmits the additional information (e.g.: coding parameters) to the channel coder 2 or to the channel decoder 3 or generates additional packets containing the additional information for upload to the application layer.

Various procedures for generating the headers, for modifying the data packets, for using the additional information, for quantizing the additional information are explained hereinbelow.

Generation of the Additional Packets at the Application Package Level and Extraction of the Additional Packets at the Network Access Level.

The method according to the invention makes it possible to transmit the additional information from the application package level to the network access level. In particular (FIG. 2) the SSI or SAI information may be utilized at the network access level. For systems using header compression, this is achieved by generating, at the application package level, additional packets containing the additional information. These packets may thereafter be transmitted via a dedicated port number. These packets will be transmitted without ARQ (automatic repeat request) capability, as they will not actually be transmitted but intercepted at the network access level. At the network access level, the header compression module which traditionally performs the header compression and consequently has knowledge of the structure of the packets, is modified to test the presence of the dedicated port:
if the presence of the dedicated port is found, the module recognizes the additional packet as such and eliminates it from the data stream. The useful part of the data is thereafter extracted to be used by the channel decoder (demodulator, etc.)
if the port is not a dedicated port, the conventional mechanism is applied.
   Generation of Header of Valid Packets to Transmit the Information to the Application Package Level

The header compression mechanism relies on the fact that the IP, UDP, RTP variable header fields in the protocol stack have a fixed syntax which may readily be reconstructed on the basis of partial information (typically the STATIC, STATIC-DEF and CHANGING classes).

By a similar principle, the mechanism of reconstruction by the header compression module (operating in decompression mode) may also, in parallel with the stream of initial data, reconstruct additional packets on the basis of the same header fields. The principle, illustrated hereinbelow in the IPv4 case, naturally remains valid in the IPv6 case. FIG. 11 shows an example of application of this principle with 3 classes of header fields:

RECOPIED: corresponds to the fields which are directly copied from the valid data packets. In practice, these fields belong mainly to the STATIC, STATIC-DEF and STATIC-KNOWN classes but may also be of the CHANGING class, recopied as is (for example the time label or time stamp),

INFERRED: as in the ROHC process, these fields are derived directly from the other header fields,

SPECIFICALLY DERIVED (specifically calculated): these fields are those which are modified specially to allow the transmission of the additional information. In particular:
the destination port which will allow the user to separate the stream of initial data from the stream of additional data and thus to avoid disturbing the customary manner of operation of the various protocols (RTCP for example). It is proposed that the initial data and the additional information be transported on two distinct port numbers (UDP, TCP);
the checksum (the UDP check total) which depends on the useful part of the data. It must be recalculated as a function of the new useful parts that the additional packets transport,
the sequence number which will be used to identify the correspondence between the original packet and the additional packet,
the useful data part which will be replaced with the additional information to be transmitted.

RECOPIED={Ver, Hd.L, TdeS, Identification, R, M, L, offset, TTL, Protocol, Source Address, Destination Address (IPv4), Source Port (UDP), Ver, P, E, CCnt, M, P.Type,Timestamp,Identification Source Synchronisation (SSRC) Identification Source Contribution 1^{st}, CSRC, Identification Source Contribution last)

INFERRED={Packet Length, Checksum (IPv4), Datagram Length (UDP)}

SPECIFICALLY DERIVED={Destination Port, checksum, Sequence number (UDP)}

Modification of the Original Packets as a Function of the User'S Requirements

It is possible for the user to modify the headers of the initial packets. The method of reconstructing the headers may be adapted to specific requirements of transmission with the additional information. For example, the checksum on the useful part of the data (UDP checksum) may be neutralized for example by being set to zero. In this case, an error in the useful part of the data will not lead to an elimination of this packet whose useful part may be corrected by virtue of the soft decoding of the source.

FIG. 12 gives an exemplary modification of the classification of the headers of the packets for the original packets in the RTP/UDP/IPv4 stack. The bold, italic, underlined, upper case or lower case characters are respected between the figure and the description.

INFERRED=(Packet Length, Checksum (IPv4), Datagram Length (UDP))

STATIC={Ver, M, L, Protocol (IPv4), P, E (UDP)} STATIC-DEF={Source Address, Destination address, Source Port, Destination Port, Identification Source Synchronisation (SSRC)}STATIC-KNOWN={Hd.L., R. L, Offset, Ver}

CHANGING={TdeS, Identification, TTL, CCnt,M, P.type, Sequence Number, Timestamp, Identification Source Contribution 1st, CSRC, Identification Source Contribution (Last),}

SPECIFICALLY DERIVED={checksum (UDP)}

Such modifications will not disturb the transmission of the information: the original packet is transmitted normally through the protocol stack. If no header protocol comprises any errors, the packet crosses through the whole of the protocol stack and is received at the application package level. The RTCP packets are thus transmitted normally and the quality of service (QoS) of the transmission is guaranteed.

Extraction of the Information Present at the Network Access Level and Integration of this Information Into the Valid Additional Packets for Use at the Application Package Level.

Several cases may be envisaged for transmitting the additional information, CSI, DRI. This information is formatted so as to be inserted into the additional packets. These packets transporting binary units (bits), the information must consequently be transformed into bits.

In the case of the decoder reliability information or of any information directly proportional to the useful data, use is made of a step of quantization [2] applied to a given number k of bits, as is illustrated in FIG. 13. The real information b=(b1, b2, . . . bn) is quantized to obtain c=(c₁₁, . . . cₙₖ) with bi≅(ci₁, ci₂, . . . , cᵢₖ). The coefficients ci are binary elements.

In the case of information relating to the channel state, or for any information of size that is not proportional to the useful data (and in practice fairly short), this involves a method of quantization or of modeling over a number k of given bits, as is illustrated in FIG. 14. The additional information is quantized according to a model defined previously by the user. The sequence d=(c₁, c₂, . . . , Ck) where ci ε {0, 1} is a binary element, therefore represents the state of the channel or any similar information.

Likewise, on output from the source coder/decoder or channel coder/decoder, a quantizer is disposed so as to generate the DRI or SSI quantized information.

This extraction of information having been carried out, the quantized values are transmitted in parallel with the standard stream to the header compression module which will utilize them.

Possible Expressions for the Fields Entitled ‘SPECIFICALLY DERIVED’

The fields presented hereinabove as being specially derived are intended to allow the method of transmitting additional information. A few examples are given by way of wholly nonlimiting illustration:
the destination port may be chosen either dynamically, for example as the first port directly available above the port customarily used or else be recorded as a dedicated port for such a transmission, (the registration, defined by the IANA organization, of the dedicated ports that may be found at the internet address http://www.iana.org),
the sequence number. This number may thereafter be used to identify the initial packets of the additional packets,
the part of the useful data may be derived as was detailed previously by quantizing the additional information. For the reliability information, the number k may be taken equal to 4 or 5. The first quantization bit is for example taken equal to the hard value (estimate of the original data) for better effectiveness. For a piece of additional information, such as SSI or CSI, the format would have to be determined in a specific manner between the two coders. For example, the CSI information could be coded on 4 levels, very bad, bad, good, very good, this corresponding to two information bits.
   Possible Applications

The method according to the invention applies for example in respect of networks with very low rate and limited band. For example it is used for wireless transmissions constructed on a network with protocol stack with header compression such as an IP/UDP/RTP network implementing the ROHC mechanism.

It also applies in networks with an outward and return retransmission time (Return Time Trip or RTT) where the use of the CSI information may aid the behavior of the source decoder to choose between the retransmission requested or the application of the cancellation techniques or else of other processing of the data received, doing so as a function of the probability of the chance of correctly receiving the information at the second request.

This method may also have advantages when the information on the information stream originating from the source such as the SSI information may be provided by the source coder to the decoder of the channel. This is for example the case when the unequal error protection (UEP) is carried out at the network access level.

FIG. 15 represents an exemplary implementation of the invention being a combined wire transmission/wireless transmission context where the additional information may be used for example between each user and its point of input, each being separated from the other by a transmission channel of low reliability.

### REFERENCES

[1] A. Tanenbaum. Computer networks. Prentice-Hall, New York, 3^{rd} edition, 1996.
[2] J. G. Proakis. Digital Communications. McGraw-Hill Book Company, New York, 3^{rd} edition, 1995.
[3] LINUX Device Drivers. Alessandro Rubini, O'Reilly & Associates, February 1998.
[4] S. McCanne and V. Jacobson, “The BSD Packet Filter: A new Architecture for User level Packet Capture,” Proc. USENIX'93, San Diego, USA, January 1993.
[5] S. Mérigeault and C. Lamy, “Concepts for Exchanging Extra Information Between Protocol Layers Transparently for the Standard Protocol Stack,” 10^{th} International Conference on Telecommunications (ICT'2003), Feb. 23-Mar. 1, 2003, Tahiti, French Polynesia.
[6] C. Bormann et al., “Robust Header Compression (ROHC): framework and four profiles: RTP, UDP, EPS, and uncompressed”, July 2001, RFC 3095.
[7] “Requirements for robust IP/UDP/RTP header compression”, RFC 3096.
[8] W. R. Stevens. TCP/IP Illustrated volume 1: the protocols. Addison Wesley Professional Computing Series, January 1999.

1-8. (canceled)

9. A method for exchanging data between two layers of a network stack in a data transmission system comprising a header compression and/or decompression mechanism, comprising the following steps:
for a transmission of the information from the network access level to the application package level, generating estimated original data and quantized additional information, and transmitting the two streams thereafter to a header compression step which generates packets containing reconstructed data and packets containing additional information; and
for a transmission of the information from the application package level to the network access level, generating useful data packets with compressed header on the basis of the packets including the useful data and the packets including the additional information and transmitting the two streams thus sent over the transmission channel.

10. The method as claimed in claim 9, wherein for the transmission of the information flowing from the network access level to the application package level, comprising the following steps:
differentiating the information originating from the transmission channel or from the channel decoder into a stream of initial packets and a stream of previously quantized additional information,
transmitting the coded initial packets and the additional information to a header decompression step,
shaping the quantized additional information as a function of the characteristics of the protocol stack,
transmitting the two streams thus obtained to a source coding step.

11. The method as claimed in claim 9, wherein for the transmission of the information flowing from the network access level to the application package level, comprising at least the following steps:
differentiating the information originating from the transmission channel or from the channel decoder into a stream of initial packets and a stream of previously quantized additional information,
transmitting the coded initial packets and the additional information to a header decompression step,
shaping the quantized additional information as a function of the characteristics of the protocol stack,
transmitting the two streams thus obtained to a source decoding step.

12. The method as claimed in claim 9, wherein for the transmission of information flowing from the application package level to the network access level, comprising the following steps:
differentiating the packets originating from the protocol stack into a stream of initial packets and a stream of additional information packets,
compressing the headers of the initial packets and transmitting them to a channel coding step,
shaping the additional information by extracting some additional information for transmission to the channel coding step,
transmitting the stream generated by the channel coding for sending to the transmission channel.

13. The method as claimed in claim 9, wherein for the transmission of information flowing from the application package level to the network access level, comprising the following steps:
differentiating the packets originating from the protocol stack into a stream of initial packets and a stream of additional information packets,
compressing the headers of the initial packets and transmitting them to a channel coding step of the access layer,
shaping the additional information by extracting some additional information for transmission to the channel decoding step,
transmitting the stream generated by the channel coding for sending over the transmission channel.

14. The method as claimed in claim 9, wherein the transmission of information flowing from the application package level to the network access level, and it comprises at least the following steps:
differentiating the packets originating from the protocol stack into a stream of initial packets and a stream of additional information packets,
compressing the headers of the initial packets and transmitting them to a channel coding step,
shaping the packets transporting the additional information quantized by header compression as a function of the characteristics of the protocol stack for transmission to the channel coding step,
transmitting the streams generated by the channel coding for sending over the transmission channel.

15. The method as claimed in claim 9, wherein the decompression step consists in differentiating the packets originating from the transmission channel, reconstructing the original packets of data, transmitting the additional information generated to the channel coder or to the channel decoder.

16. The method as claimed in claim 9, wherein the decompression step consists in differentiating the packets originating from the transmission channel, reconstructing the original packets of data, generating additional packets containing the additional information and transmitting them to the application package level.

17. The method as claimed in claim 10, wherein the decompression step includes differentiating the packets originating from the transmission channel, reconstructing the original packets of data, transmitting the additional information generated to the channel coder or to the channel decoder.

18. The method as claimed in claim 11, wherein the decompression step includes differentiating the packets originating from the transmission channel, reconstructing the original packets of data, transmitting the additional information generated to the channel coder or to the channel decoder.

19. The method as claimed in claim 10, wherein the decompression step includes differentiating the packets originating from the transmission channel, reconstructing the original packets of data, generating additional packets containing the additional information and transmitting them to the application package level.

20. The method as claimed in claim 11, wherein the decompression step includes differentiating the packets originating from the transmission channel, reconstructing the original packets of data, generating additional packets containing the additional information and transmitting them to the application package level.

21. The method as claimed in claim 15, wherein the decompression step includes differentiating the packets originating from the transmission channel, reconstructing the original packets of data, generating additional packets containing the additional information and transmitting them to the application package level.

22. A method for exchanging data between two layers of a network stack in a data transmission system comprising a header compression and/or decompression mechanism, comprising the following steps:
for a transmission of the information from the application package level to the network access level, generating useful data packets with compressed header on the basis of the packets including the useful data and the packets including the additional information and transmitting the two streams thus sent over the transmission channel.

23. The method as claimed in claim 22, wherein for the transmission of the information flowing from the network access level to the application package level, comprising at least the following steps:
differentiating the information originating from the transmission channel or from the channel decoder into a stream of initial packets and a stream of previously quantized additional information,
transmitting the coded initial packets and the additional information to a header decompression step,
shaping the quantized additional information as a function of the characteristics of the protocol stack,
transmitting the two streams thus obtained to a source decoding step.

24. The method as claimed in claim 22, wherein for the transmission of information flowing from the application package level to the network access level, comprising the following steps:
differentiating the packets originating from the protocol stack into a stream of initial packets and a stream of additional information packets,
compressing the headers of the initial packets and transmitting them to a channel coding step of the access layer,
shaping the additional information by extracting some additional information for transmission to the channel decoding step,
transmitting the stream generated by the channel coding for sending over the transmission channel.

25. The method as claimed in claim 22, wherein the transmission of information flowing from the application package level to the network access level, and it comprises at least the following steps:
differentiating the packets originating from the protocol stack into a stream of initial packets and a stream of additional information packets,
compressing the headers of the initial packets and transmitting them to a channel coding step,
shaping the packets transporting the additional information quantized by header compression as a function of the characteristics of the protocol stack for transmission to the channel coding step,
transmitting the streams generated by the channel coding for sending over the transmission channel.
